(19) United States
(12) Patent Application Publication
(10) Pub. No.: US 2022/0111853 A1
(43) Pub. Date: Apr. 14, 2022

(54) TARGET VEHICLE CONTROL METHOD AND APPARATUS, ELECTRONIC DEVICE, AND STORAGE MEDIUM

(71) Applicant: BEIJING SENSETIME TECHNOLOGY DEVELOPMENT CO., LTD., Beijing (CN)

(72) Inventors: Hui ZHOU, Beijing (CN); Zhe WANG, Beijing (CN); Jianping SHI, Beijing (CN)

(21) Appl. No.: 17/560,375

(22) Filed: Dec. 23, 2021

Related U.S. Application Data
(63) Continuation of application No. PCT/CN2021/089399, filed on Apr. 23, 2021.

(30) Foreign Application Priority Data
Jun. 30, 2020 (CN) 202010619833.1

(51) Int. Cl. B60W 40/10; G06V 20/58

(52) U.S. Cl. CPC B60W 40/10; B60W 2420/42; B60W 2554/4049; G06V 20/58

(57) ABSTRACT

A target vehicle control method and apparatus, an electronic device, and a storage medium are provided. The control method includes that: a plurality of frames of point cloud collected by a radar apparatus are acquired during traveling of a target vehicle; obstacle detection is performed on each frame of point cloud, and the current position and confidence of a target obstacle are determined; and the target vehicle is controlled to travel based on the determined current position and confidence of the target obstacle and current position and pose data of the target vehicle.

### CROSS-REFERENCE TO RELATED APPLICATION

This application is a U.S. continuation application of International Application No. PCT/CN2021/089399, filed on Apr. 23, 2021, which is based upon and claims priority to Chinese Application No. 202010619833.1, filed on Jun. 30, 2020 and entitled “TARGET VEHICLE CONTROL METHOD AND APPARATUS, ELECTRONIC DEVICE, AND STORAGE MEDIUM”. The contents of International Application No. PCT/CN2021/089399 and Chinese Application No. 202010619833.1 are hereby incorporated by reference in their entireties.

### BACKGROUND

In the field of assisted driving or automatic driving, a point cloud image may be acquired by a radar, whether a target obstacle exists may be determined on the basis of the point cloud image, and when the existence of the target obstacle is detected, a vehicle may be controlled to travel, such as whether to decelerate to avoid the obstacle, on the basis of the detected position of the target obstacle.

### SUMMARY

The present disclosure relates to the technical field of automatic driving, and in particular, to a target vehicle control method and apparatus, an electronic device, and a storage medium.

The embodiments of the present disclosure at least provide a target vehicle control solution.

In a first aspect, the embodiments of the present disclosure provide a target vehicle control method. The control method may include the following operations.

A plurality of frames of point cloud collected by a radar apparatus may be acquired during traveling of a target vehicle.

Obstacle detection may be performed on each frame of point cloud, and the current position and confidence of a target obstacle may be determined.

The target vehicle may be controlled to travel based on the determined current position and confidence of the target obstacle and current position and pose data of the target vehicle.

In a second aspect, the embodiments of the present disclosure provide a target vehicle control apparatus. The control apparatus may include: an acquisition module, a determination module, and a control module.

The acquisition module may be configured to acquire a plurality of frames of point cloud collected by a radar apparatus during traveling of a target vehicle.

The determination module may be configured to perform obstacle detection on each frame of point cloud, and determine the current position and confidence of a target obstacle.

The control module may be configured to control the target vehicle to travel based on the determined current position and confidence of the target obstacle and current position and pose data of the target vehicle.

In a third aspect, the embodiments of the present disclosure provide an electronic device, including a processor, a memory, and a bus. The memory stores machine-readable instructions executable for the processor. When the electronic device runs, the processor communicates with the memory through a bus. The machine-readable instructions, when executed by the processor, steps of the control method as described in the first aspect are executed.

In a fourth aspect, the embodiments of the present disclosure provide a computer-readable storage medium, in which computer programs are stored. The computer programs are executed by a processor to perform steps of the target vehicle control method described in the first aspect.

In order to make the above purpose, characteristics, and advantages of the present disclosure clearer and easier to understand, detailed descriptions will be made below with the preferred embodiments in combination with the drawings.

### BRIEF DESCRIPTION OF THE DRAWINGS

For describing the technical solutions of the embodiments of the present disclosure more clearly, the drawings required to be used in the embodiments will be simply introduced below. The drawings, which are incorporated in and constitute a part of this specification, illustrate embodiments consistent with the present disclosure and, jointly with the specification, serve to explain the technical solutions of the present disclosure. It is to be understood that the following drawings only illustrate some embodiments of the present disclosure and thus should not be considered as limitation to the scope. Those of ordinary skill in the art may also obtain other related drawings according to these drawings without creative work.

FIG. 1 is a flowchart of a target vehicle control method provided by embodiments of the present disclosure.

FIG. 2 is a flowchart of a method for determining tracking matching confidence corresponding to a target obstacle provided by the embodiments of the present disclosure.

FIG. 3 is a flowchart of a method for determining predicted position information of the target obstacle provided by the embodiments of the present disclosure.

FIG. 4 is a flowchart of a method for determining a velocity smoothing length provided by the embodiments of the present disclosure.

FIG. 5 is a flowchart of a method for determining an acceleration smoothing length provided by the embodiments of the present disclosure.

FIG. 6 is a schematic structural diagram of a target vehicle control apparatus provided by the embodiments of the present disclosure.

FIG. 7 is a schematic diagram of an electronic device provided by the embodiments of the present disclosure.

### DETAILED DESCRIPTION

In order to make the purpose, technical solutions, and advantages of the present disclosure clearer, the technical solutions in the embodiments of the present disclosure are clearly and completely elaborated below in combination with the drawings of the present disclosure. It is apparent that the described embodiments are not all but only part of embodiments of the present disclosure. Components, described and shown in the accompanying drawings, of the embodiments of the present disclosure may usually be arranged and designed with various configurations. Therefore, the following detailed description of the embodiments of the present disclosure provided in the accompanying drawings is not intended to limit the scope of the present disclosure, but only represents the selected embodiments of the present disclosure. On the basis of the embodiments of the present disclosure, all other embodiments obtained by those skilled in the art without creative work shall fall within the scope of protection of the present disclosure.

It is to be noted that similar reference signs and letters represent similar terms in the following drawings and thus a certain term, once being defined in a drawing, are not required to be further defined and explained in subsequent drawings.

Point cloud images within a set range from a target vehicle may be acquired at set time intervals during traveling of the target vehicle. Further, position information of a target obstacle within the set range from the target vehicle may be detected on the basis of the point cloud images. For example, the point cloud images may be input into a neural network configured to detect an obstacle, and the target obstacle included in the point cloud images and the position information of the target obstacle are output and obtained. Considering that the detected position information of the target obstacle in the point cloud images may be inaccurate due to various situations, such as a detection error of the neural network and a detection problem of point cloud data, so that the confidence of the position information of the target obstacle, i.e., the reliability degree of the accuracy of the position information of the target obstacle, will be given when the position information of the target obstacle is detected. When the confidence is high, the vehicle may be controlled to decelerate to avoid the obstacle on the basis of the position information of the target obstacle. When the confidence is low, the vehicle may still be controlled to decelerate to avoid the obstacle on the basis of the previously detected position information of the target obstacle with high confidence. Therefore, how to improve the confidence of the detected target obstacle is critical, which will be discussed in the embodiments of the present disclosure.

Based on the above researches, the present disclosure provides a target vehicle control method. A plurality of frames of point cloud collected by a radar apparatus are acquired, and obstacle detection is performed on each frame of point cloud, the current position and confidence of a target obstacle are determined. Illustratively, each frame of point cloud may be detected, so as to determine whether the frame of point cloud includes the target obstacle, and the position information of the target obstacle in the frame of point cloud. Thus, the position change of the target obstacle in the plurality of frames of point cloud may be tracked jointly through the plurality of frames of point cloud. In this way, the accuracy of the confidence that the determined target obstacle appears at the current position is improved, so as to realize effective control of the target vehicle when the vehicle is controlled on the basis of the confidence. Illustratively, frequent stops or collisions caused by false detection of the target obstacle can be avoided.

In order to facilitate the understanding of the embodiments, a target vehicle control method disclosed in the embodiments of the present disclosure is introduced in detail firstly. The execution subject of the target vehicle control method provided in the embodiments of the present disclosure is generally a computer device with certain computing capacity. The computer device includes, for example, a terminal device or a server or other processing devices. The terminal device may be User Equipment (UE), a mobile device, a user terminal, a computing device, a vehicle device, etc. In some possible implementation manners, the control method may be implemented by means of a processor calling a computer-readable instruction stored in the memory.

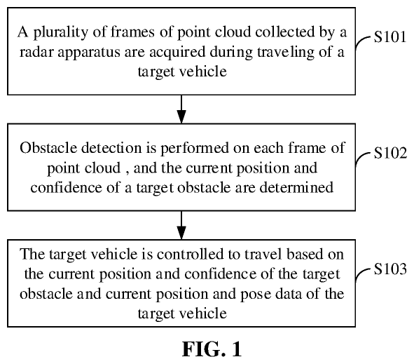

As shown in FIG. 1 which is a flowchart of a target vehicle control method provided by the embodiments of the present disclosure, the method includes S101 to S103.

At S101, a plurality of frames of point cloud collected by a radar apparatus are acquired during traveling of a target vehicle.

Illustratively, the radar apparatus may include a lidar apparatus, a millimeter-wave radar apparatus, an ultrasonic radar apparatus, etc., which is not specifically limited herein.

Illustratively, taking the lidar apparatus as an example, the lidar apparatus can obtain one frame of point cloud by scanning 360 degrees. When the radar apparatus is arranged on the target vehicle, with the traveling of the target vehicle, the radar apparatus can collect point cloud according to the set time intervals, and a plurality of frames of point cloud can be obtained in this way.

Illustratively, the plurality of frames of point cloud here may be a plurality of continuous frames of point cloud collected according to the set time intervals. For the current frame of point cloud, the plurality of continuous frames of point cloud may include the current frame of point cloud and a plurality of frames of point cloud collected within a preset time length before and after the collection time of the current frame of point cloud.

At S102, obstacle detection is performed on each frame of point cloud, and the current position and confidence of a target obstacle are determined.

Illustratively, the operation that the obstacle detection is performed on each frame of point cloud may include detecting the position and confidence of the target obstacle in each frame of point cloud, or also include detecting the velocity of the target obstacle in each frame of point cloud, or also include detecting the acceleration of the target obstacle in each frame of point cloud. The current position and the confidence of the target obstacle may be determined by a plurality of detection manners jointly.

The current position of the target obstacle in each frame of point cloud may be the current position of the target obstacle in a coordinate system where the target vehicle is located. The confidence is the probability that the target obstacle appears at the current position. Here, when the probability that the target obstacle appears at the current position is determined, it may be determined by performing obstacle detection on the plurality of frames of point cloud that are collected at current time and are collected in a set time period before the current time.

Illustratively, when the obstacle detection is performed on each frame of point cloud, one or more obstacles included in the frame of point cloud may be detected, an obstacle in a traveling direction of the target vehicle may be taken as a target obstacle here. When one frame of point cloud includes a plurality of obstacles, the target obstacles in the plurality of frames of point cloud may be determined on the basis of the numbers corresponding to various determined obstacles in each frame of point cloud. The embodiments of the present disclosure will be described by determining the confidence of one of the target obstacles. When there are a plurality of obstacles, a plurality of target obstacles may be determined, and each target obstacle may be determined in the same way.

At S103, the target vehicle is controlled to travel based on the determined current position and confidence of the target obstacle and current position and pose data of the target vehicle.

Further, the probability that the target obstacle appears at the current position may be determined on the basis of the confidence after the current position and the confidence of the target vehicle are determined. Illustratively, when it is determined that the probability that the target obstacle appears at the current position is high, the target vehicle may be controlled to travel on the basis of the current position of the target obstacle and the current position and pose data of the target vehicle. On the contrary, when it is determined that the probability that the target obstacle appears at the current position is low, the current position of the target obstacle may not be considered when the target vehicle is controlled to travel, or the target vehicle is controlled to travel on the basis of previous position information of the target obstacle and the current position and pose data of the target vehicle.

Specifically, when the target vehicle is controlled to travel on the basis of the current position and confidence of the target obstacle and the current position and pose data of the target vehicle, the method may include the following operations.

(1) In the case where it is determined that the confidence corresponding to the target obstacle is higher than a preset confidence threshold value, distance information between the target obstacle and the target vehicle is determined on the basis of the current position of the target obstacle and the current position and pose data of the target vehicle.

(2) The target vehicle is controlled to travel on the basis of the distance information.

Specifically, the current position and pose data of the target vehicle may include the current position of the target vehicle and the current traveling direction of the target vehicle. Thus, the current relative distance between the target obstacle and the target vehicle may be determined according to the current position of the target vehicle and the current position of the target obstacle. The distance information between the target obstacle and the target vehicle is determined in combination with the current traveling direction of the target vehicle. The distance information may be used to predict whether the target vehicle will collide with the target obstacle if continuing to travel in the original direction and the original speed, so that the target vehicle may be controlled to travel on the basis of the distance information.

Illustratively, the target vehicle may be controlled according to the distance information and a preset safety level. For example, if the safety distance level that the distance information belongs is low, the vehicle can be braked in an emergency. If the safety distance level that the distance information belongs is high, the vehicle can decelerate to travel along the original direction.

In the embodiments of the present disclosure, the position change of the target obstacle in the plurality of frames of point cloud may be tracked jointly through the plurality of frames of point cloud. In this way, the accuracy of the confidence that the determined target obstacle appears at the current position is improved, so as to realize effective control of the target vehicle when the vehicle is controlled on the basis of the confidence. Illustratively, frequent stops or collisions caused by false detection of the target obstacle can be avoided.

In order to improve the accuracy of the confidence, the confidence proposed by the embodiments of the present disclosure is determined according to at least two of the following parameters: average detection confidence, tracking matching confidence, effective length of a tracking chain, velocity smoothness, and acceleration smoothness.

The average detection confidence represents the average reliability degree that the detected target obstacle is at the position corresponding to each frame of point cloud in a detection process for the plurality of frames of point cloud. The tracking matching confidence may represent the matching degree between the detected target obstacle and the tracking chain, and the tracking chain may be a plurality of continuous frames of point cloud. The effective length of the tracking chain may represent the number of frames in which target obstacles are detected in the plurality of continuous frames of point cloud. The velocity smoothness may represent the velocity change degree of the velocity of the target obstacle in a time period corresponding to the plurality of continuous frames of point cloud. The acceleration smoothness may represent the acceleration change degree of the velocity of the target obstacle in the time period corresponding to the plurality of continuous frames of point cloud.

When the confidence of an obstacle is determined according to the above various parameters, the various parameters are all positively correlated with the confidence. The embodiments of the present disclosure propose to determine the confidence of the current position of the target obstacle according to at least two of the above parameters, and the confidence of the target obstacle at the current position is determined through a plurality of parameters jointly, so that the accuracy of the confidence of the determined target obstacle at the current position can be improved.

Specifically, when the confidence of the target obstacle is determined, the method may include the following operations.

The confidence of the target obstacle is obtained after weighted summation or multiplication is performed on at least two parameters.

When the weighted summation is performed on the basis of the above at least two parameters, the confidence of the target obstacle may be determined according to the following formula (1).

$${C}_{j} = {\sum }_{i = 1}^{n} {w}_{i} {P}_{i}^{j} \qquad ( 1 )$$

Herein, i represents a variable i∈(1,n); n represents a total number of parameters, wᵢ represents a preset weight of the ith parameter, and Pᵢ^{j} represents a parameter value of the ith parameter of the target obstacle with the number of j; and Cⱼ represents the confidence of the target obstacle with the number of j. When the point cloud image includes only one target obstacle, here j is 1.

Illustratively, the preset weight corresponding to each parameter may be set in advance. For example, the importance of influence of each parameter on the confidence is determined in advance through big data statistics.

In another implementation mode, when multiplication is performed on the basis of the above at least two parameters, the confidence of the target obstacle may be determined according to the following formula (2).

$${C}_{j} = {\prod }_{i = 1}^{n} {P}_{i}^{j} \qquad ( 2 )$$

In the embodiments of the present disclosure, it is proposed to determine the confidence that the target obstacle is at the current position through a plurality of parameters jointly. Thus, when the confidence of the target obstacle is determined from a plurality of perspectives, the accuracy of the confidence corresponding to the target obstacle at the current position can be improved.

Determination processes of the plurality of above parameters are respectively described below.

In an implementation mode, the average detection confidence may be determined according to the following manner.

The average detection confidence corresponding to the target obstacle is determined according to the detection confidence that the target obstacle appears in each frame of point cloud.

Specifically, each frame of point cloud is input into a pre-trained neural network configured to detect and track an obstacle. The neural network includes a first module for detecting the position of the obstacle in each frame of point cloud, and a second module for tracking a target obstacle. After each frame of point cloud is input into the neural network, a bounding box representing the position of the target obstacle in the frame of point cloud and the detection confidence of the bounding box may be obtained through the first module, and the number of the obstacles included in each frame of point cloud may be determined through the second module, so that the target obstacle is determined.

Specifically, the second module in the neural network may detect the similarity of the obstacles included in the continuously input point cloud to determine the same obstacle in different frames of point cloud, and may number the obstacles included in each frame of point cloud. In different frames of point cloud, the same obstacle corresponds to the same number, so that the target obstacle may be determined in different frames of point cloud.

Further, after the detection confidence corresponding to the target obstacle in each frame of point cloud is obtained, the average detection confidence corresponding to the target obstacle may be determined according to the following formula (3).

$${P}_{i = 1}^{j} = \frac{1}{L} {\sum }_{t = 1}^{L} {p}_{t}^{j} \qquad ( 3 )$$

Pᵢ₌₁^{j} Represents the average detection confidence of the target obstacle with the number of j, L represents the number of frames of point cloud, and pₜ^{j} represents the detection confidence corresponding to the target obstacle with the number of j in the tth frame of point cloud of a plurality of continuous frames of point cloud.

L may be a set number of frames, for example, L=10 is set in advance, which represents that continuous 10 frames of point cloud are detected; t=1 represents the first frame of point cloud in the 10 frames of point cloud. During traveling of the target vehicle, the 10 frames of continuous point cloud are also dynamically variable with the gradual increase of the collected point cloud, t=L is the current frame of point cloud image, and t=1 represents the first frame of point cloud in the 10 frames of continuous point cloud including the current frame of point cloud and 9 frames of point cloud collected in a history stage.

Particularly, when the number of frames of point cloud collected by a radar apparatus during this working process does not reach the set number of frames, the L is the total number of frames collected from a collection starting time to the current time. For example, if the set number of frames is 10 frames, and the point cloud collected at the current time is the 7th frame of point cloud collected by the radar apparatus during this working process, when the confidence of the target obstacle at the current position is determined, the L here is equal to 7. When the number of frames of point cloud collected by the radar apparatus during this working process reaches the set number of frames, the L here is always equal to the set number of frames. This working process of the radar apparatus refers to a process that the radar apparatus is started to collect the point cloud images this time.

Particularly, when the point cloud images are collected according to preset time intervals, each time corresponds to one frame of point cloud image. Therefore, the above t=1 may also represent the point cloud image corresponding to the first collection time within a collection time length corresponding to the plurality of continuous point cloud images. Here, the first collection time is dynamically variable, and is not the starting time of the radar apparatus during this working process.

In the embodiments of the present disclosure, it is proposed that parameters for determining the confidence of the target obstacle include average detection confidence. The average detection confidence can reflect the average reliability degree of the position of the target obstacle in the plurality of frames of point cloud. When the confidence of the target obstacle is determined on the basis of the average detection confidence, the stability of the confidence of the determined target obstacle can be improved.

In one possible implementation mode, the tracking matching confidence is determined according to the following mode.

The tracking matching confidence that the target obstacle is a tracking object matched with the plurality of frames of point cloud is determined on the basis of the position information of the target obstacle in each frame of point cloud.

The position information of the target obstacle in each frame of point cloud may be determined according to the pre-trained neural network. After each frame of point cloud is input into the neural network, the position information of the bounding box representing the target obstacle in the frame of point cloud may be detected.

Considering that the plurality of frames of point cloud are collected by the radar apparatus according to the preset time intervals, the time interval between two adjacent frames of point cloud in the plurality of frames of point cloud is short. In a short time, the displacement change degree of the same target obstacle is generally less than a certain range. Based on this, the tracking matching confidence that the target obstacle is the tracking object matched with the plurality of frames of point cloud may be determined.

Specifically, when the plurality of continuous frames of point cloud include the same tracking object, the plurality of continuous frames of point cloud may be taken as a tracking chain of the tracking object. The position information change of the tracking object in two adjacent frames of point cloud in the tracking chain should be less than a preset range. Based on this, according to the position information of the target obstacle in each frame of point cloud, whether the tracked target obstacle is the tracking object matched with the tracking chain may be judged, or whether the target obstacle in the tracking chain is the same target obstacle may be judged. For example, the tracking chain includes 10 frames of point cloud. For the target obstacle with the number of 1, whether the target obstacles with the number of 1 in the tracking chain are the same target obstacle may be determined according to the position information of the target obstacle with the number of 1 in each frame of point cloud, that is, whether the target obstacle is the tracking object matched with the tracing chain is judged. The tracking matching confidence here may be used to represent the matching degree between the target obstacle with the number of 1 and the tracking chain. The matching degree is higher, the probability that the target obstacle is the tracking object matched with the tracking chain is higher. On the contrary, the probability that the target obstacle is the tracking object matched with the tracking chain is lower.

In the embodiments of the present disclosure, the probability that the target obstacle appears in the plurality of continuous frames of point cloud is represented by the tracking matching confidence. If it is determined that the probability that the target obstacle appears in the plurality of continuous frames of point cloud is higher, the probability that the target obstacle is a false detection result is lower. Based on this, the tracking matching confidence of the target obstacle and the tracking chain may be taken as a parameter for determining the confidence of the target obstacle, so as to improve the accuracy of the confidence.

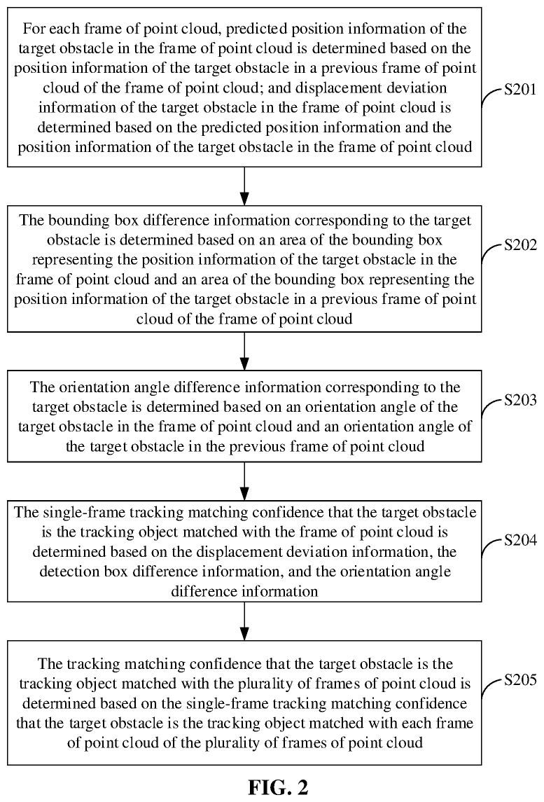

Specifically, when the tracking matching confidence that the target obstacle is a tracking object matched with the plurality of frames of point cloud is determined on the basis of the position information of the target obstacle in each frame of point cloud, as shown in FIG. 2, the method may include the following steps of S201 to S205.

At S201, for each frame of point cloud, predicted position information of the target obstacle in the frame of point cloud is determined based on the position information of the target obstacle in a previous frame of point cloud of the frame of point cloud; and displacement deviation information of the target obstacle in the frame of point cloud is determined based on the predicted position information and the position information of the target obstacle in the frame of point cloud.

According to the abovementioned method for determining the position information of the target obstacle in each frame of point cloud, the position information of the target obstacle in each frame of point cloud may be determined. Specifically, the position information representing a center point of a bounding box of the target obstacle in each frame of point cloud may be taken as the position information of the target obstacle in the frame of point cloud.

If the time interval between two frames of point cloud, such as the nth frame of point cloud and the (n+1)th frame of point cloud, the velocity corresponding to the target obstacle at the collection time of the nth frame of point cloud, and the position information of the target obstacle in the nth frame of point cloud are known, the predicted position information of the target obstacle in the (n+1)th frame of point cloud may be predicted, herein n is a natural number greater than 0.

Further, the displacement deviation information of the target obstacle in the frame of point cloud may be determined on the basis of the predicted position information for the target obstacle and the position information of the target obstacle in the frame of point cloud. The displacement deviation information may be used as one of the parameters for evaluating whether the target obstacle is matched with the tracking chain.

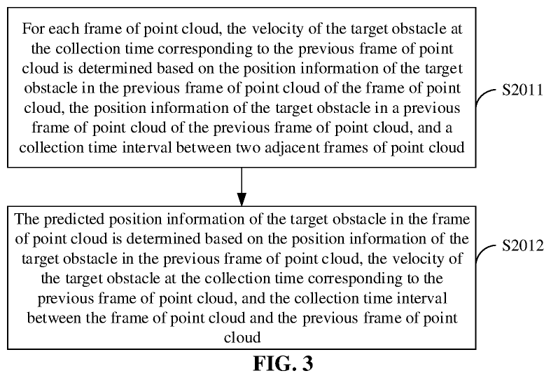

Specifically, for the above S201, when the predicted position information of the target obstacle in the frame of point cloud is determined on the basis of the position information of the target obstacle in the previous frame of point cloud of the frame of point cloud, as shown in FIG. 3, the method may include the following steps of S2011 and S2012.

At S2011, for each frame of point cloud, the velocity of the target obstacle at the collection time corresponding to the previous frame of point cloud is determined based on the position information of the target obstacle in the previous frame of point cloud of the frame of point cloud, the position information of the target obstacle in a previous frame of point cloud of the previous frame of point cloud, and a collection time interval between two adjacent frames of point cloud.

At S2012, the predicted position information of the target obstacle in the frame of point cloud is determined based on the position information of the target obstacle in the previous frame of point cloud, the velocity of the target obstacle at the collection time corresponding to the previous frame of point cloud image, and the collection time interval between the frame of point cloud and the previous frame of point cloud.

Specifically, for each frame of point cloud, the average velocity of the target obstacle in the collection time interval between two adjacent frames of point cloud may be determined on the basis of the position information of the target obstacle in the previous frame of point cloud of the frame of point cloud (specifically referring to the position information of the center point of the bounding box), the position information of the target obstacle in the previous frame of point cloud of the previous frame of point cloud (specifically referring to the position information of the center point of the bounding box), and a collection time interval between two adjacent frames of point cloud. The average velocity is taken as the velocity of the target obstacle at the collection time corresponding to the previous frame of point cloud.

Further, taking the collection time corresponding to the frame of point cloud being the time corresponding to when the t-th frame of point cloud of the plurality of continuous frames of point cloud as an example, when the predicted position information of the target obstacle in the frame of point cloud is determined, it may be determined according to the following formula (4).

$$p r e {d}_{t}^{j} = {det}_{t - 1}^{j} + {v}_{t - 1}^{j} * Δ t \qquad ( 4 )$$

Herein, predₜ^{j} presents the predicted position information of the target obstacle with the number of j in the t-th frame of point cloud of the plurality of continuous frames of point cloud, detₜ₋₁^{j} represents the position information of the target obstacle with the number of j in the (t-1)th frame of point cloud of the plurality of continuous frames of point cloud, vₜ₋₁^{j} represents the velocity of the target obstacle with the number of j in the (t-1)th frame of point cloud of the plurality of continuous frames of point cloud, and Δt represents the time interval between collecting the tth frame of point cloud and collecting the (t-1)th frame of point cloud image.

Further, the displacement deviation information of the target obstacle in the frame of point cloud may be determined on the basis of the following formula (5).

$$Δ {L}_{t}^{j} = T - ‖ {pred}_{t}^{j} - {det}_{t}^{j} ‖ \qquad ( 5 )$$

Herein, ΔLₜ^{j} represents the displacement deviation information of the target obstacle with the number of j in the t-th frame of point cloud of the plurality of continuous frames of point cloud, detₜ^{j} represents the position information of the collected target obstacle with the number of j in the t-th frame of point cloud of the plurality of continuous frames of point cloud, and T represents a preset parameter.

At S202, the bounding box difference information corresponding to the target obstacle is determined based on an area of the bounding box representing the position information of the target obstacle in the frame of point cloud and an area of the bounding box representing the position information of the target obstacle in a previous frame of point cloud of the frame of point cloud image.

Similarly, if the time interval between two frames of point cloud is short, the position information of the same target obstacle in the two frames of point cloud should be relatively close. Therefore, the bounding box difference information of the target obstacle in the two frames of point cloud may be used as one of the parameters for evaluating whether the target obstacle is matched with the tracking chain.

Specifically, the area of the bounding box corresponding to the target obstacle with the number of j in the (t-1)th frame of point cloud of the plurality of continuous frames of point cloud may be determined according to the following formula (6), the area of the bounding box corresponding to the target obstacle with the number of j in the t-th frame of point cloud of the plurality of continuous frames of point cloud may be determined according to the following formula (7), and the bounding box difference information of the target obstacle with the number of j in the t-th frame of point cloud of the plurality of continuous frames of point cloud may be determined according to the following formula (8).

$$\begin{matrix}{s}_{t - 1}^{j} = {w}_{t - 1}^{j} * {h}_{t - 1}^{i} & ( 6 ) \\ {s}_{t}^{j} = {w}_{t}^{j} * {h}_{t}^{j} & ( 7 ) \\ Δ {D}_{t}^{j} = \frac{min ( {s}_{t - 1}^{j} , {s}_{t}^{j} )}{max ( {s}_{t - 1}^{j} , {s}_{t}^{j} )} & ( 8 )\end{matrix}$$

Herein, sₜ₋₁^{j} represents the area of the bounding box corresponding to the target obstacle with the number of j in the (t-1)th frame of point cloud of the plurality of continuous frames of point cloud, wₜ₋₁^{j} represents the width of the bounding box corresponding to the target obstacle with the number of j in the (t-1)th frame of point cloud of the plurality of continuous frames of point cloud, hₜ₋₁^{j} represents the height of the bounding box corresponding to the target obstacle with the number of j in the (t-1)th frame of point cloud of the plurality of continuous frames of point cloud, represents the area of the bounding box corresponding to the target obstacle with the number of j in the t-th frame of point cloud of the plurality of continuous frames of point cloud, wₜ^{j} represents the width of the bounding box corresponding to the target obstacle with the number of j in the t-th frame of point cloud of the plurality of continuous frames of point cloud, hₜ^{j} represents the height of the bounding box corresponding to the target obstacle with the number of j in the t-th frame of point cloud of the plurality of continuous frames of point cloud, and ΔDₜ^{j} represents the bounding box difference information of the target obstacle with the number of j in the t-th frame of point cloud of the plurality of continuous frames of point cloud.

At S203, the orientation angle difference information corresponding to the target obstacle is determined based on an orientation angle of the target obstacle in the frame of point cloud and an orientation angle of the target obstacle in the previous frame of point cloud.

Similarly, if the time interval between two frames of point cloud is short, the orientation angles of the same target obstacle in the two frames of point cloud should be relatively close. Therefore, the orientation angle difference information of the target obstacle in the two frames of point cloud may be used as one of the parameters for evaluating whether the target obstacle is matched with the tracking chain.

Specifically, the orientation angle difference information corresponding to the target obstacle may be determined according to the following formula (9).

$$Δ {H}_{t}^{j} = cos ( {θ}_{t}^{j} - {θ}_{t - 1}^{j} ) \qquad ( 9 )$$

Herein, ΔHₜ^{j} represents the orientation angle difference information of the target obstacle with the number of j in the t-th frame of point cloud of the plurality of continuous frames of point cloud, θₜ^{j} represents an orientation angle corresponding to the target obstacle with the number of j in the t-th frame of point cloud of the plurality of continuous frames of point cloud, and θₜ₋₁^{j} represents an orientation angle corresponding to the target obstacle with the number of j in the (t-1)th frame of point cloud of the plurality of continuous frames of point cloud.

Illustratively, the orientation angle corresponding to the target obstacle in the t-th frame of point cloud of the plurality of continuous frames of point cloud specifically refers to the orientation angle of the target obstacle when the t-th frame of point cloud is collected, and the orientation angle of the target obstacle in the point cloud may be determined according to the following manner.

Firstly, a positive direction is set in a three-dimensional space, for example, taking a direction perpendicular to the ground and pointing to the sky as the positive direction, and then taking an included angle formed by the positive direction and a connecting line between a center point of the bounding box corresponding to the target obstacle in the point cloud and a vehicle as an orientation angle of the target obstacle in the frame of point cloud.

At S204, the single-frame tracking matching confidence that the target obstacle is the tracking object matched with the frame of point cloud is determined based on the displacement deviation information, the bounding box difference information, and the orientation angle difference information.

Illustratively, weighted summation may also be performed on the basis of the displacement deviation information, the bounding box difference information, and the orientation angle difference information. For example, the weighted summation is performed on the above obtained ΔLₜ^{j}, ΔDₜ^{j}, ΔHₜ^{j}, so that the single-frame tracking matching confidence that the target obstacle is the tracking object matched with the t-th frame of point cloud of the plurality of continuous frames of point cloud may be obtained.

Specifically, the single-frame tracking matching confidence that the target obstacle is the tracking object matched with the t-th frame of point cloud of the plurality of continuous frames of point cloud may be determined according to the following formula (10).

$${p}_{t}^{{j}^{′}} = {w}_{Δ L} Δ {L}_{t}^{j} + {w}_{Δ D} Δ {D}_{t}^{j} + {w}_{Δ H} Δ {H}_{t}^{j} \qquad ( 10 )$$

Herein, pₜ^{j′} represents the single-frame tracking matching confidence that the target obstacle with the number of j is the tracking object matched with the t-th frame of point cloud of the plurality of continuous frames of point cloud, w_{ΔL} represents the preset weight of the displacement deviation information, w_{ΔD} represents the preset weight of the bounding box difference information, and w_{ΔH} represents the preset weight of the orientation angle difference information.

The single-frame tracking matching confidence that the target obstacle is the tracking object matched with each frame of point cloud may be obtained according to the above manner.

Specifically, the single-frame tracking matching confidence that the target obstacle is the tracking object matched with each frame of point cloud may represent the reliability degree that the target obstacle in the frame of point cloud and the target obstacle in the previous frame of point cloud are the same target obstacle.

For example, a preset tracking chain is continuous 10 frames of point cloud. For the second frame of point cloud image, the single-frame tracking matching confidence that the target obstacle is the tracking object matched with the second frame of point cloud represents the reliability degree that the target obstacle in the second frame of point cloud and the target obstacle in the first frame of point cloud are the same target obstacle. Similarly, for the third frame of point cloud, the single-frame tracking matching confidence that the target obstacle is the tracking object matched with the third frame of point cloud represents the reliability degree that the target obstacle in the third frame of point cloud and the target obstacle in the second frame of point cloud are the same target obstacle.

At S205, the tracking matching confidence that the target obstacle is the tracking object matched with the plurality of frames of point cloud is determined based on the single-frame tracking matching confidence that the target obstacle is the tracking object matched with each frame of point cloud of the plurality of frames of point cloud.

Specifically, the tracking matching confidence that the target obstacle is the tracking object matched with the plurality of frames of point cloud may be determined according to the following formula (11).

$${P}_{i = 2}^{j} = \frac{1}{L} {\sum }_{t = 1}^{L} {p}_{t}^{{j}^{′}} \qquad ( 11 )$$

Herein, Pᵢ₌₂^{j} represents the tracking matching confidence that the target obstacle with the number of j is the tracking object matched with the plurality of frames of point cloud.

It may determine from the formula (11) that the tracking matching confidence corresponding to the target obstacle may be obtained by averaging the single-frame tracking matching confidence corresponding to the target obstacle.

In the embodiments of the present disclosure, parameters for determining the confidence of the target obstacle includes the tracking matching confidence. The tracking matching confidence can reflect the reliability degree that the target obstacle belongs to the tracking object of the plurality of frames of point cloud. Thus, the accuracy of the confidence of the target obstacle can be improved by taking the parameter into consideration when the confidence of the target obstacle is determined on the basis of the plurality of frames of point cloud.

In one possible implementation mode, in the case where at least two parameters include the effective length of the tracking chain, the effective length of the tracking chain may be determined according to the following manner.

The number of missed frames for the target obstacle in the plurality of frames of point cloud is determined on the basis of the position information of the target obstacle in each frame of point cloud; and the effective length of the tracking chain is determined on the basis of the total number of frames and the number of missed frames corresponding to the plurality of frames of point cloud.

Each frame of point cloud is input into a pre-trained neural network, and in the case where the neural network runs normally, the position information of the target obstacle included in the frame of point cloud may be output. If the position information of the target obstacle included in the frame of point cloud is not output, the frame of point cloud may be determined as a missed point cloud image. In the embodiments of the present disclosure, the plurality of frames of point cloud are the point cloud images that are continuously collected in a short time. For the tracking chain corresponding to the same target obstacle and including the plurality of continuous frames of point cloud, when the first frame of point cloud and the last frame of point cloud include the target obstacle, each frame of point cloud located between the first frame of point cloud and the last frame of point cloud will also generally include the target obstacle. Therefore, if the point cloud image output by the neural network does not include the position information of the target obstacle, then the point cloud image may be taken as a missed point cloud image.

Specifically, the effective length of the tracking chain may be determined according to the following formula (12).

$${P}_{i = 3}^{j} = 1 + η * {log}_{10}^{( L - NL ) / L} \qquad ( 12 )$$

Herein, Pᵢ₌₃^{j} represents the effective length of the tracking chain of the target obstacle with the number of j, η represents a preset weight coefficient, L represents the number of frames of the plurality of frames of point cloud, and NL represents the number of missed frames.

In the embodiments of the present embodiments, it is proposed to take the effective length of the tracking chain as a parameter for determining the confidence of the target obstacle. The accuracy of the neural network for detecting the target obstacle in each frame of point cloud is determined by the effective length of the tracking chain, so that the accuracy of the confidence can be improved when the confidence of the target obstacle is determined based on the effective length of the tracking chain.

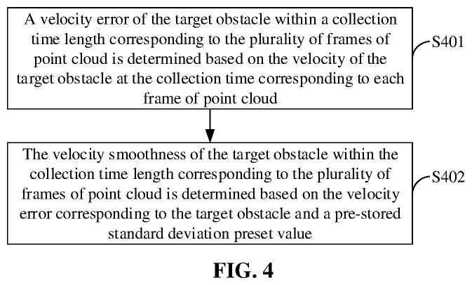

In another possible implementation mode, in the case where at least two parameters include the velocity smoothness, as shown in FIG. 4, the velocity smoothness may be determined according to the following manner, which specifically includes the following steps of S401 to S402.

At S401, a velocity error of the target obstacle within a collection time length corresponding to the plurality of frames of point cloud is determined based on the velocity of the target obstacle at the collection time corresponding to each frame of point cloud image.

At S402, the velocity smoothness of the target obstacle within the collection time length corresponding to the plurality of frames of point cloud is determined based on the velocity error corresponding to the target obstacle and a pre-stored standard deviation preset value.

Illustratively, the velocity error corresponding to a plurality of velocities may be determined in a manner similar to Kalman filtering algorithm. The velocity error may represent the noise of the velocity of the target obstacle within the collection time length corresponding to the plurality of frames of point cloud.

Specifically, the velocity smoothness of the target obstacle within the collection time length corresponding to the plurality of frames of point cloud may be determined through to the following formula (13).

$${P}_{i = 4}^{j} = \frac{1}{\sqrt{2 π} * σ} exp ( - \frac{{( δ v )}^{2}}{2 * {σ}^{2}} ) \qquad ( 13 )$$

Herein, Pᵢ₌₄^{j} represents the velocity smoothness of the target obstacle with the number of j within the collection time length corresponding to the plurality of frames of point cloud, σ represents the pre-stored standard deviation preset value, and δv represents the velocity error of the target obstacle within the collection time length corresponding to the plurality of frames of point cloud.

The velocity smoothness corresponding to the target obstacle may represent the velocity stability degree of the target obstacle within the collection time length corresponding to the plurality of frames of point cloud. The velocity is determined on the basis of the position information of the target obstacle in two adjacent frames of point cloud, so the velocity stability degree is higher, the displacement deviation change of the target obstacle in two adjacent frames of point cloud is smaller, and thus, the position of the detected target obstacle is more accurate.

In the embodiments of the present disclosure, the velocity smoothness can reflect the velocity change smoothness of the target obstacle, and can reflect the position change situation of the target obstacle in the plurality of continuous frames of point cloud, which can reflect the reliability degree of the position information of the detected target obstacle. Based on this, the velocity smoothness may be taken as a parameter for determining the confidence of the target obstacle, so as to improve the accuracy of the confidence.

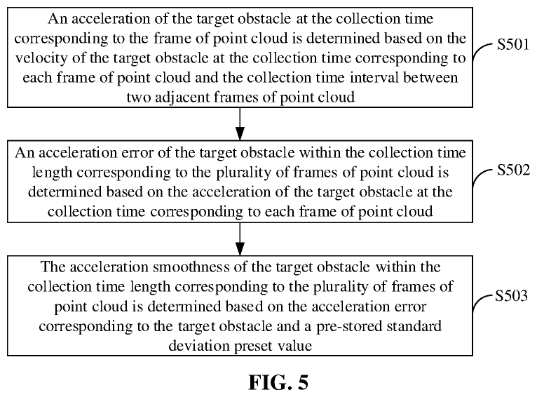

In another possible implementation mode, in the case where at least two parameters include acceleration smoothness, as shown in FIG. 5, the acceleration smoothness may be determined according to the following manner, which specifically includes the following steps of S501 to S503.

At S501, an acceleration of the target obstacle at the collection time corresponding to the frame of point cloud is determined based on the velocity of the target obstacle at the collection time corresponding to each frame of point cloud and the collection time interval between two adjacent frames of point cloud.

At S502, an acceleration error of the target obstacle within the collection time length corresponding to the plurality of frames of point cloud is determined based on the acceleration of the target obstacle at the collection time corresponding to each frame of point cloud.

At S503, the acceleration smoothness of the target obstacle within the collection time length corresponding to the plurality of frames of point cloud is determined based on the acceleration error corresponding to the target obstacle and a pre-stored standard deviation preset value.

Illustratively, the method for determining the velocity of the target obstacle at the collection time corresponding to each frame of point cloud is described above, and will not be elaborated herein. Further, the acceleration of the target obstacle at the collection time corresponding to the frame of point cloud may be determined based on the collection time interval between two adjacent frames of point cloud and the velocity of the target obstacle at the collection time corresponding to each frame of point cloud.

Illustratively, the acceleration error corresponding to a plurality of accelerations may also be determined in a manner similar to Kalman filtering algorithm. The acceleration error may represent the noise of the acceleration of the target obstacle within the collection time length corresponding to the plurality of frames of point cloud.

Specifically, the velocity smoothness of the target obstacle within the collection time length corresponding to the plurality of frames of point cloud may be determined through to the following formula (14).

$${P}_{i = 5}^{j} = \frac{1}{\sqrt{2 π} * σ} exp ( - \frac{{( δ a )}^{2}}{2 * {σ}^{2}} ) \qquad ( 14 )$$

Herein, Pᵢ₌₅^{j} represents the acceleration smoothness of the target object with the number of j within the collection time length corresponding to the plurality of frames of point cloud, σ represents the pre-stored standard deviation preset value, and δa represents the acceleration error of the target object within the collection time length corresponding to the plurality of frames of point cloud.

The acceleration smoothness corresponding to the target obstacle may represent the acceleration stability degree of the target obstacle within the collection time length corresponding to the plurality of frames of point cloud. The acceleration stability degree is higher, the velocity changes of the target obstacle within the collection time length corresponding to the plurality of continuous frame of point cloud is more stable, and further, the position of the detected target obstacle is more accurate.

In the embodiments of the present disclosure, the acceleration smoothness can reflect the acceleration change smoothness of the target obstacle, can reflect the velocity change situation of the target obstacle within the collection time length corresponding to the plurality of continuous frames of point cloud, and can also reflect the position change situation of the target obstacle in the plurality of continuous frames of point cloud, which can reflect the reliability degree of the position information of the detected target obstacle. Based on this, the acceleration smoothness may be taken as a parameter for determining the confidence of the target obstacle, so as to improve the accuracy of the confidence.

It can be understood by those skilled in the art that, in the above-mentioned method of the specific implementation modes, the writing sequence of each step does not mean a strict execution sequence and is not intended to form any limitation to the implementation process and a specific execution sequence of each step should be determined by functions and probable internal logic thereof.

Based on the same inventive conception, the embodiments of the present disclosure further provide a control apparatus corresponding to the target vehicle control method. The principle of the apparatus in the embodiments of the present disclosure for solving the problem is similar to the above target vehicle control method of the embodiments of the present disclosure, so implementation of the apparatus may refer to implementation of the method. Repeated parts will not be elaborated.

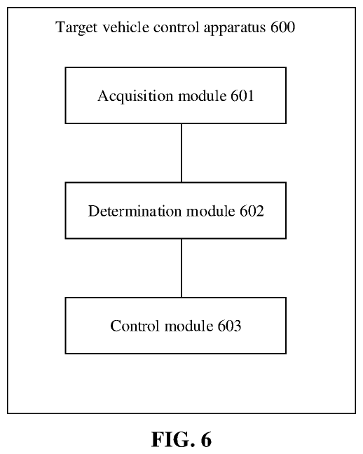

Referring to FIG. 6, which is a schematic structural diagram of a target vehicle control apparatus provided by the embodiments of the present disclosure, the control apparatus includes an acquisition module 601, a determination module 602, and a control module 603.

The acquisition module 601 is configured to acquire, during traveling of a target vehicle, a plurality of frames of point cloud collected by a radar apparatus.

The determination module 602 is configured to perform obstacle detection on each frame of point cloud, and determine the current position and the confidence of a target obstacle.

The control module 603 is configured to control the target vehicle to travel based on the determined current position and confidence of the target obstacle and current position and pose data of the target vehicle.

In one possible implementation mode, the confidence is determined according to at least two of the following parameters: average detection confidence, tracking matching confidence, effective length of a tracking chain, velocity smoothness, and acceleration smoothness.

The determination module 602 is specifically configured to perform the following operations.

The confidence of the target obstacle is obtained after weighted summation or multiplication is performed on at least two parameters.

In one possible implementation mode, the determination module 602 is also configured to determine the average detection confidence according to the following manner.

The average detection confidence corresponding to the target obstacle is determined according to the detection confidence that the target obstacle appears in each frame of point cloud.

In one possible implementation mode, the determination module 602 is also configured to determine a tracking matching confidence according to the following manner.

The tracking matching confidence that the target obstacle is a tracking object matched with the plurality of frames of point cloud is determined based on the position information of the target obstacle in each frame of point cloud.

In one possible implementation mode, the determination module 602 is specifically configured to perform the following operations.

For each frame of point cloud, predicted position information of the target obstacle in the frame of point cloud is determined based on the position information of the target obstacle in a previous frame of point cloud of the frame of point cloud. Displacement deviation information of the target obstacle in the frame of point cloud is determined based on the predicted position information and the position information of the target obstacle in the frame of point cloud.

The bounding box difference information corresponding to the target obstacle is determined based on an area of a bounding box representing the position information of the target obstacle in the frame of point cloud and an area of the bounding box representing the position information of the target obstacle in a previous frame of point cloud of the frame of point cloud.

The orientation angle difference information corresponding to the target obstacle is determined based on an orientation angle of the target obstacle in the frame of point cloud and an orientation angle of the target obstacle in the previous frame of point cloud.

Single-frame tracking matching confidence that the target obstacle is a tracking object matched with the frame of point cloud is determined based on the displacement deviation information, the bounding box difference information and the orientation angle difference information.

The tracking matching confidence that the target obstacle is a tracking object matched with the plurality of frames of point cloud is determined according to the single-frame tracking matching confidence that the target obstacle is the tracking object matched with each frame of point cloud of the plurality of frames of point cloud.

In one possible implementation mode, the determination module 602 is specifically configured to perform the following operations.

For each frame of point cloud, the velocity of the target obstacle at the collection time corresponding to the previous frame of point cloud is determined based on the position information of the target obstacle in the previous frame of point cloud of the frame of point cloud, the position information of the target obstacle in a previous frame of point cloud of the previous frame of point cloud, and a collection time interval between two adjacent frames of point cloud.

The predicted position information of the target obstacle in the frame of point cloud is determined based on the position information of the target obstacle in the previous frame of point cloud, the velocity of the target obstacle at the collection time corresponding to the previous frame of point cloud, and the collection time interval between the frame of point cloud and the previous frame of point cloud.

In one possible implementation mode, the determination module 602 is also configured to determine the effective length of a tracking chain according to the following manner.

The number of missed frames for the target obstacle in the plurality of frames of point cloud is determined based on the position information of the target obstacle in each frame of point cloud; and the effective length of the tracking chain is determined based on the total number of frames and the number of missed frames corresponding to the plurality of frames of point cloud.

In one possible implementation mode, the determination module 602 is also configured to determine velocity smoothness according to the following mode.

A velocity error of the target obstacle within a collection time length corresponding to the plurality of frames of point cloud is determined based on the velocity of the target obstacle at the collection time corresponding to each frame of point cloud.

The velocity smoothness of the target obstacle within the collection time length corresponding to the plurality of frames of point cloud is determined based on the velocity error corresponding to the target obstacle and a pre-stored standard deviation preset value.

In one possible implementation mode, the determination module 602 is also configured to determine acceleration smoothness according to the following manner.

The acceleration of the target obstacle at a collection time corresponding to the frame of point cloud is determined based on the velocity of the target obstacle at the collection time corresponding to each frame of point cloud and the collection time interval between two adjacent frames of point cloud.

A velocity error of the target obstacle within a collection time length corresponding to the plurality of frames of point cloud is determined based on the velocity of the target obstacle at the collection time corresponding to each frame of point cloud.

The velocity smoothness of the target obstacle within the collection time length corresponding to the plurality of frames of point cloud is determined based on the velocity error corresponding to the target obstacle and a pre-stored standard deviation preset value.

In one possible implementation mode, the control module 603 is specifically configured to perform the following operations.

In the case where it is determined that the confidence corresponding to the target obstacle is higher than a preset confidence threshold value, distance information between the target obstacle and the target vehicle is determined based on the current position of the target obstacle and the current position and pose data of the target vehicle.

The target vehicle is controlled to travel based on the distance information.

The descriptions about the processing flow of each module in the apparatus and interaction flows between various modules may refer to the related descriptions in the abovementioned method embodiment, and will not be elaborated herein.

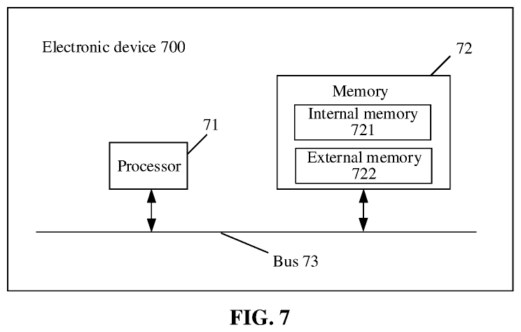

For the target vehicle control method of FIG. 1, the embodiments of the present disclosure further provide an electronic device 700. As shown in FIG. 7, which is a schematic structural diagram of the electronic device 700 provided by the embodiments of the present disclosure, and the electronic device includes a processor 71, a memory 72, and a bus 703.

The memory 72 is configured to store an execution instruction, and includes an internal memory 721 and an external memory 722. The internal memory 721 here is also called an internal memory, and is configured to temporarily store operation data in the processor 71, and data exchanged with the external memory, such as a hard disc. The processor 71 exchanges data with the external memory 722 through the internal memory 721. When the electronic device 700 runs, the processor 71 communicates with the memory through the bus 73, so that the processor 71 executes the following instructions. A plurality of frames of point cloud collected by a radar apparatus may be acquired during traveling of a target vehicle. Obstacle detection is performed on each frame of point cloud, and the current position and confidence of a target obstacle are determined. The target vehicle is controlled to travel based on the current position and confidence of the target obstacle and current position and pose data of the target vehicle.

The embodiments of the present disclosure further provide a computer-readable storage medium, in which computer programs are stored. The computer programs are run by the processor to execute the steps of the target vehicle control method in the above method embodiments. The computer-readable storage medium may be a nonvolatile or volatile computer readable storage medium.

A computer program product of the target vehicle control method provided in the embodiments of the present disclosure includes a computer-readable storage medium, in which program codes are stored. Instructions included in the program codes may be configured to execute steps of the target vehicle control method as described in the above method embodiments. References may specifically be made to the above method embodiments and will not be elaborated here.

The embodiments of the present disclosure further provide a computer program. When executed by the processor, the computer program implements any method in the foregoing embodiments. The computer program product may be specifically realized by means of hardware, software or a combination thereof. In an optional embodiment, the computer program product is specifically embodied as a computer storage medium, and in another optional embodiment, the computer program product is specifically embodied as software products, such as a Software Development Kit (SDK).

Those skilled in the art may clearly learn about that specific working processes of the system and apparatus described above may refer to the corresponding processes in the method embodiment and will not be elaborated herein for convenient and brief description. In the several embodiments provided in the present disclosure, it should be understood that the disclosed system, apparatus, and method may be implemented in other modes. The apparatus embodiment described above is only schematic, and for example, division of the units is only logic function division, and other division modes may be adopted during practical implementation. For another example, a plurality of units or components may be combined or integrated into another system, or some characteristics may be neglected or not executed. In addition, the displayed or discussed mutual couplings or direct couplings or communication connections may be implemented through some communications interfaces. The indirect couplings or communication connections between the apparatuses or modules may be implemented in electrical, mechanical, or other forms.

The units described as separate parts may or may not be physically separated, and parts displayed as units may or may not be physical units, and namely may be located in the same place, or may also be distributed to multiple network units. Some or all of the units may be selected based on actual requirements to achieve the objectives of the solutions of the embodiments.

In addition, each functional unit in each embodiment of the present disclosure may be integrated into a processing unit, each unit may also physically exist independently, and two or more than two units may also be integrated into a unit.

When the functions are implemented in a form of a software functional unit and sold or used as an independent product, the functions may be stored in a non-volatile computer-readable storage medium executable for the processor. Based on such an understanding, the technical solutions of the present disclosure substantially or parts making contributions to the conventional art or part of the technical solutions may be embodied in form of software product, and the computer software product is stored in a storage medium, including a plurality of instructions configured to enable a computer device (which may be a personal computer, a server, a network device, or the like) to execute all or part of the steps of the method in each embodiment of the present disclosure. The foregoing storage medium includes: various media capable of storing program codes, such as a USB flash disc, a mobile hard disc, a Read-Only Memory (ROM), a Random Access Memory (RAM), a magnetic disc, or a compact disc.

It is finally to be noted that the above embodiments are only the specific implementation modes of the present disclosure and are adopted not to limit the present disclosure but to describe the technical solutions of the present disclosure. The scope of protection of the present disclosure is not limited thereto. Although the present disclosure is described with reference to the embodiments in detail, those of ordinary skill in the art should know that those skilled in the art may still make modifications or apparent variations to the technical solutions recorded in the embodiments or make equivalent replacements to part of technical features within the technical scope disclosed in the present disclosure, and these modifications, variations, or replacements do not make the essence of the corresponding technical solutions departs from the spirit and scope of the technical solutions of the embodiments of the present disclosure and shall fall within the scope of protection of the present disclosure. Therefore, the scope of protection of the present disclosure shall be subject to the scope of protection of the claims.

### INDUSTRIAL APPLICABILITY

The embodiments of the present disclosure disclose a target vehicle control method and apparatus, an electronic device, and a storage medium. The control method includes: a plurality of frames of point cloud collected by a radar apparatus are acquired during traveling of a target vehicle; obstacle detection is performed on each frame of point cloud, and the current position and the confidence of a target obstacle are determined; and the target vehicle is controlled to travel based on the current position and confidence of the target obstacle and current position and pose data of the target vehicle. By the above solution, the position change of the target obstacle in the plurality of frames of point cloud may be tracked jointly through the plurality of frames of point cloud. In this way, the accuracy of the confidence that the determined target obstacle appears at the current position is improved, so as to realize effective control of the target vehicle when the vehicle is controlled based on the confidence. Illustratively, frequent stops or collisions caused by false detection of the target obstacle can be avoided.

1. A target vehicle control method, comprising:
acquiring, during traveling of a target vehicle, a plurality of frames of point cloud collected by a radar apparatus;
performing obstacle detection on each frame of point cloud, and determining a current position and confidence of a target obstacle; and
controlling the target vehicle to travel based on the determined current position and confidence of the target obstacle and current position and pose data of the target vehicle.

2. The control method of claim 1, wherein the confidence is determined according to at least two of following parameters: an average detection confidence, a tracking matching confidence, an effective length of a tracking chain, a velocity smoothness, and an acceleration smoothness;
the determining the confidence of the target obstacle comprises:
obtaining the confidence of the target obstacle after weighted summation or multiplication is performed on the at least two parameters.

3. The control method of claim 2, wherein the average detection confidence is determined according to the following manner:
determining an average detection confidence corresponding to the target obstacle according to a detection confidence that the target obstacle appears in each frame of point cloud.

4. The control method of claim 2, wherein the tracking matching confidence is determined according to the following manner:
determining a tracking matching confidence that the target obstacle is a tracking object matched with the plurality of frames of point cloud based on position information of the target obstacle in each frame of point cloud.

5. The control method of claim 4, wherein the determining the tracking matching confidence that the target obstacle is a tracking object matched with the plurality of frames of point cloud based on the position information of the target obstacle in each frame of point cloud comprises:
for each frame of point cloud image, determining predicted position information of the target obstacle in the frame of point cloud based on the position information of the target obstacle in a previous frame of point cloud of the frame of point cloud; determining displacement deviation information of the target obstacle in the frame of point cloud based on the predicted position information and the position information of the target obstacle in the frame of point cloud;
determining bounding box difference information corresponding to the target obstacle based on an area of a bounding box representing the position information of the target obstacle in the frame of point cloud and an area of the bounding box representing the position information of the target obstacle in a previous frame of point cloud of the frame of point cloud;
determining orientation angle difference information corresponding to the target obstacle based on an orientation angle of the target obstacle in the frame of point cloud and an orientation angle of the target obstacle in the previous frame of point cloud;
determining, based on the displacement deviation information, the bounding box difference information and the orientation angle difference information, single-frame tracking matching confidence that the target obstacle is a tracking object matched with the frame of point cloud; and
determining, according to a single-frame tracking matching confidence that the target obstacle is a tracking object matched with each frame of point cloud of the plurality of frames of point cloud, the tracking matching confidence that the target obstacle is the tracking object matched with the plurality of frames of point cloud.

6. The control method of claim 5, wherein the for each frame of point cloud, determining predicted position information of the target obstacle in the frame of point cloud based on the position information of the target obstacle in a previous frame of point cloud of the frame of point cloud comprises:
for each frame of point cloud, determining a velocity of the target obstacle at a collection time corresponding to the previous frame of point cloud based on the position information of the target obstacle in the previous frame of point cloud of the frame of point cloud, the position information of the target obstacle in a previous frame of point cloud of the previous frame of point cloud, and a collection time interval between two adjacent frames of point cloud; and
determining the predicted position information of the target obstacle in the frame of point cloud based on the position information of the target obstacle in the previous frame of point cloud, the velocity of the target obstacle at the collection time corresponding to the previous frame of point cloud, and a collection time interval between the frame of point cloud and the previous frame of point cloud.

7. The control method of claim 2, wherein the effective length of the tracking chain is determined according to the following manner:
determining a number of missed frames for the target obstacle in the plurality of frames of point cloud based on position information of the target obstacle in each frame of point cloud; and determining the effective length of the tracking chain based on a total number of frames and the number of missed frames corresponding to the plurality of frames of point cloud.

8. The control method of claim 2, wherein the velocity smoothness is determined according to the following manner:
determining a velocity error of the target obstacle within a collection time length corresponding to the plurality of frames of point cloud based on a velocity of the target obstacle at a collection time corresponding to each frame of point cloud; and
determining a velocity smoothness of the target obstacle within the collection time length corresponding to the plurality of frames of point cloud based on a velocity error corresponding to the target obstacle and a pre-stored standard deviation preset value.

9. The control method of claim 2, wherein the acceleration smoothness is determined according to the following manner:
determining an acceleration of the target obstacle at a collection time corresponding to the frame of point cloud based on a velocity of the target obstacle at a collection time corresponding to each frame of point cloud and a collection time interval between two adjacent frames of point cloud;
determining an acceleration error of the target obstacle within a collection time length corresponding to the plurality of frames of point cloud based on an acceleration of the target obstacle at the collection time corresponding to each frame of point cloud; and
determining the acceleration smoothness of the target obstacle within the collection time length corresponding to the plurality of frames of point cloud based on the acceleration error corresponding to the target obstacle and a pre-stored standard deviation preset value.

10. The control method of claim 1, wherein the controlling the target vehicle to travel based on the determined current position and confidence of the target obstacle and the current position and pose data of the target vehicle comprises:
in the case where it is determined that the confidence corresponding to the target obstacle is higher than a preset confidence threshold value, determining distance information between the target obstacle and the target vehicle based on the current position of the target obstacle and the current position and pose data of the target vehicle; and
controlling the target vehicle to travel based on the distance information.

11. An electronic device, comprising a processor, a memory, and a bus, wherein the memory stores machine-readable instructions executable for the processor; when the electronic device runs, the processor communicates with the memory through the bus; and the machine-readable instructions, when executed by the processor, caused the processor to perform the following operations:
acquiring, during traveling of a target vehicle, a plurality of frames of point cloud collected by a radar apparatus;
performing obstacle detection on each frame of point cloud, and determine a current position and confidence of a target obstacle; and
controlling the target vehicle to travel based on the determined current position and confidence of the target obstacle and current position and pose data of the target vehicle.

12. The electronic device of claim 11, wherein the confidence is determined according to at least two of following parameters: an average detection confidence, a tracking matching confidence, an effective length of a tracking chain, a velocity smoothness, and an acceleration smoothness;
the determining the confidence of the target obstacle comprises:
obtaining the confidence of the target obstacle after weighted summation or multiplication is performed on the at least two parameters.

13. The electronic device of claim 12, wherein the average detection confidence is determined according to the following manner:
determining an average detection confidence corresponding to the target obstacle according to a detection confidence that the target obstacle appears in each frame of point cloud.

14. The electronic device of claim 12, wherein the tracking matching confidence is determined according to the following manner:
determining a tracking matching confidence that the target obstacle is a tracking object matched with the plurality of frames of point cloud based on position information of the target obstacle in each frame of point cloud.

15. The electronic device of claim 14, wherein the determining the tracking matching confidence that the target obstacle is a tracking object matched with the plurality of frames of point cloud based on the position information of the target obstacle in each frame of point cloud comprises:
for each frame of point cloud image, determining predicted position information of the target obstacle in the frame of point cloud based on the position information of the target obstacle in a previous frame of point cloud of the frame of point cloud; determining displacement deviation information of the target obstacle in the frame of point cloud based on the predicted position information and the position information of the target obstacle in the frame of point cloud;
determining bounding box difference information corresponding to the target obstacle based on an area of a bounding box representing the position information of the target obstacle in the frame of point cloud and an area of the bounding box representing the position information of the target obstacle in a previous frame of point cloud of the frame of point cloud;
determining orientation angle difference information corresponding to the target obstacle based on an orientation angle of the target obstacle in the frame of point cloud and an orientation angle of the target obstacle in the previous frame of point cloud;
determining, based on the displacement deviation information, the bounding box difference information and the orientation angle difference information, single-frame tracking matching confidence that the target obstacle is a tracking object matched with the frame of point cloud; and
determining, according to a single-frame tracking matching confidence that the target obstacle is a tracking object matched with each frame of point cloud of the plurality of frames of point cloud, the tracking matching confidence that the target obstacle is the tracking object matched with the plurality of frames of point cloud.

16. The electronic device of claim 15, wherein the for each frame of point cloud, determining predicted position information of the target obstacle in the frame of point cloud based on the position information of the target obstacle in a previous frame of point cloud of the frame of point cloud comprises:
for each frame of point cloud, determining a velocity of the target obstacle at a collection time corresponding to the previous frame of point cloud based on the position information of the target obstacle in the previous frame of point cloud of the frame of point cloud, the position information of the target obstacle in a previous frame of point cloud of the previous frame of point cloud, and a collection time interval between two adjacent frames of point cloud; and
determining the predicted position information of the target obstacle in the frame of point cloud based on the position information of the target obstacle in the previous frame of point cloud, the velocity of the target obstacle at the collection time corresponding to the previous frame of point cloud, and a collection time interval between the frame of point cloud and the previous frame of point cloud.

17. The electronic device of claim 12, wherein the effective length of the tracking chain is determined according to the following manner:
determining a number of missed frames for the target obstacle in the plurality of frames of point cloud based on position information of the target obstacle in each frame of point cloud; and determining the effective length of the tracking chain based on a total number of frames and the number of missed frames corresponding to the plurality of frames of point cloud.

18. The electronic device of claim 12, wherein the velocity smoothness is determined according to the following manner:
determining a velocity error of the target obstacle within a collection time length corresponding to the plurality of frames of point cloud based on a velocity of the target obstacle at a collection time corresponding to each frame of point cloud; and
determining a velocity smoothness of the target obstacle within the collection time length corresponding to the plurality of frames of point cloud based on a velocity error corresponding to the target obstacle and a pre-stored standard deviation preset value.

19. The electronic device of claim 12, wherein the acceleration smoothness is determined according to the following manner:
determining an acceleration of the target obstacle at a collection time corresponding to the frame of point cloud based on a velocity of the target obstacle at a collection time corresponding to each frame of point cloud and a collection time interval between two adjacent frames of point cloud;
determining an acceleration error of the target obstacle within a collection time length corresponding to the plurality of frames of point cloud based on an acceleration of the target obstacle at the collection time corresponding to each frame of point cloud; and
determining the acceleration smoothness of the target obstacle within the collection time length corresponding to the plurality of frames of point cloud based on the acceleration error corresponding to the target obstacle and a pre-stored standard deviation preset value.

20. A non-transitory computer-readable storage medium, storing computer programs, wherein when the computer programs are run by a processor, following operations are executed:
acquiring, during traveling of a target vehicle, a plurality of frames of point cloud collected by a radar apparatus;
performing obstacle detection on each frame of point cloud, and determining a current position and confidence of a target obstacle; and
controlling the target vehicle to travel based on the determined current position and confidence of the target obstacle and current position and pose data of the target vehicle.
